(19) United States
(12) Patent Application Publication
(10) Pub. No.: US 2011/0024293 A1
(43) Pub. Date: Feb. 3, 2011

(54) APPARATUS AND METHOD FOR NON IMMERSED GEL ELECTROPHORESIS

(76) Inventor: Hafid Mezdour, Villeneuve D'Ascq (FR)

Correspondence Address: BLAKELY SOKOLOFF TAYLOR & ZAFMAN LLP, 1279 OAKMEAD PARKWAY, SUNNYVALE, CA, 94085-4040, US

(21) Appl. No.: 12/936,514

(22) PCT Filed: Apr. 14, 2008
(86) PCT No.: PCT/IB08/53128

§ 371 Date: Oct. 5, 2010

(51) Int. Cl. G01N 27/447

(52) U.S. Cl. 204/456; 204/607

(57) ABSTRACT

According to a first aspect, the invention relates to an apparatus for effecting electrophoresis of biomolecules in non immersed gels, comprising means (2, 3, 4) for applying an electrical potential to the gel medium, means (5, 6, 7) for sensing the effective electrical field strength in the gel medium, and means (8) for altering the applied electrical potential in response to the sensed, effective electrical field strength in the gel medium. The invention also relates to an electrophoresis method in which the electrical potential applied to the gel medium is automatically controlled.

### BACKGROUND OF THE INVENTION

### Field of the Invention

The invention relates to electrophoresis, particularly to the regulation during gel electrophoresis of the electrical potential applied to the gel medium into which the biomolecules to be migrated are embedded.

The invention provides apparatuses and methods for effecting migration of biomolecules in a gel medium by horizontal electrophoresis, notably in a gel medium non-immersed in a buffer solution, in which the electrical potential applied to the gel medium is automatically regulated.

### Description of Related Art

Electrophoresis is a process for separating biomolecules from one another in accordance to their physico-chemical characteristics: size, conformation, electrical charge, etc.

The biomolecules can be embedded in a porous matrix such as a polyacrylamide or agarose gel.

The gel is generally immersed in a buffer solution. An electrical potential is applied to the buffer solution via a pair of electrodes having opposite polarities, whereby an electrical current flows in the gel and causes the biomolecules embedded within the gel to migrate more or less rapidly in accordance to their physico-chemical characteristics and gel porosity.

Typical steps for such a conventional electrophoresis are as follows:

Gel preparation;

Preparation and pouring samples in wells in the gel;

Migration;

Direct reading of the migration or transfer.

This conventional electrophoresis process is relatively laborious and time-consuming (in particular with regards to the migration step). Its main difficulties are indeed as follows.

Difficulties of manipulation, in particular the pouring of the samples in the wells;

Important heating of the buffer solution and of the gel during electrophoresis;

Relatively important duration of the migration, in particular due to the heating.

The heating is in part caused by the buffer solution which forms a layer covering the gel. This buffer solution layer has two functions: it protects the gel against dehydration and helps in dissipating the calories released by the gel under Joule effect.

The thickness of the buffer solution layer has therefore to meet a compromise between a good calories dissipation capability (largest possible volume) and a minimal conductivity (lowest possible volume) to reduce the heat produced by Joule effect.

Furthermore, when raising the voltage in order to accelerate the migration, a threshold can be passed and causes a feedback heating loop.

But the increase in temperature affects the quality of the separations and restricts the speed of the analysis.

In order to improve the electrophoresis technique, several electrophoresis systems have been proposed in the art.

A- Improvements to electrophoresis systems making use of a gel immersed in buffer solution
a. by continuously cooling the buffer solution by means of a pump and of a cryostat
b. by making use of low conductivity buffer solutions
c. by immersion of the central part of the gel in distilled water (which has very low thermal conductivity, but high heat absorption capacity)

B- Improvements to electrophoresis systems making use of a gel non-immersed in a buffer solution
a. by making use of gels encased in plastic cassettes containing buffer solution tanks and electrodes, the cooling being performed by passive dissipation with ambient air;
b. by making use of gels cast on flexible plastic film and placed on a cold plate.

However, even with such improvements, it proves difficult to realize analyses of high quality in a simpler and more reproducible manner.

The lack of reproducibility is notably caused by the fact that the migration speed of the biomolecules embedded within the gel is determined by the gel's length (constant) and by the effective electrical potential between the end portions of the gel. However, in most electrophoresis systems, the electrical potential which is applied to the buffer solution via a pair of electrodes may not correspond to the effective electrical potential between the end portions of the gel. Indeed the effective electrical potential not only depends upon the gel's resistivity (which varies upon its characteristics: type, length, section) but also upon the resistivity of the buffer solutions (type, concentration, volume, etc.).

It is therefore an object of the invention to propose an electrophoresis system which could solve the above mentioned drawbacks and allow for an improvement in the quality of the analyses.

It is a further object of the invention to provide for an automatic adaptation of the electrophoresis system to the change of the conditions (buffer solution type, gel size, etc.) and for a precise programming of the electrophoresis conditions.

### SUMMARY OF THE INVENTION

In this context, the invention proposes an apparatus for effecting migration of biomolecules in a gel medium by electrophoresis, comprising:

means for applying an electrical potential to the gel medium;

means for sensing the effective electrical field strength in the gel medium;

means for altering the applied electrical potential in response to the sensed effective electrical field strength in the gel medium.

Other preferred but non limitative aspects of this apparatus are as follows:

the means for altering is configured so as to alter said electrical potential to achieve a preferred effective electrical field strength in the gel medium;

said preferred effective electrical field strength is chosen so that migration of the biomolecules occurs during a preferred duration;

the apparatus comprises a tray formed with a support surface for the gel medium linking two buffer solution baths;

the tray is conformed so that when the gel medium is disposed on the support surface, only the end portions of the gel medium are immersed in the buffer solution baths;

said means for applying an electrical potential to the gel medium comprises a pair of electrodes, each electrode being fixed in respective a buffer solution bath, and a power generator for applying an electrical potential between the electrodes;

the means for sensing the effective electrical field strength in the gel medium comprises a pair of sensing electrodes disposed so as to each contact the non-immersed central portion of the gel medium on one of its end parts;

the apparatus further comprises cooling means for controlling the temperature of the gel medium;

the cooling means generates a flow of cold air around the support surface and the gel medium;

the cooling means cools the support surface;

the support surface is horizontal;

the support surface is rounded;

the support surface comprises a strip of hydrophobic material onto which wells in the gel medium for pouring samples to be migrated are to be positioned.

According to a second aspect, the invention proposes a method for effecting migration of biomolecules in a gel medium by horizontal electrophoresis, comprising the steps of:

applying an electrical potential to the gel medium

sensing the effective electrical field strength in the gel medium

altering said electrical potential in response to the sensed effective electrical field strength in the gel medium.

Other preferred but non limitative aspects of this method are as follows:

the gel medium comprises a film and a gel layer on the film, and the method further comprises the step of positioning the gel medium in an apparatus according to the first aspect of the invention with the film contacting an horizontal support surface;

the gel medium comprises a film and a gel layer on the film, and the method further comprises the preliminary step of positioning the gel medium in the apparatus according to the first aspect of the invention with the gel layer contacting a rounded support surface;

the method further comprises the preliminary step of sealing the well in the gel medium into which biomolecules to be migrated has been poured.

### BRIEF DESCRIPTION OF THE DRAWINGS

Other characteristics, purposes and advantages of the invention will appear to the reading of the following detailed description, with respect to the annexed drawings, given as non restrictive examples, in which:

FIG. 1 is a schema of an electrophoresis apparatus according to a first embodiment of the first aspect of the invention;

FIG. 2 is a perspective view of the electrophoresis apparatus of FIG. 1;

FIG. 3 shows the various components of the electrophoresis apparatus of FIG. 2;

FIGS. 4a-4b and FIGS. 4c-4d illustrate preferred embodiments of the invention relating the sealing of the wells after the biomolecules have been poured;

FIG. 5 is a schema of an electrophoresis apparatus according to a second embodiment of the first aspect of the invention;

FIG. 6 shows the various components of the electrophoresis apparatus of FIG. 5;

FIG. 7 is a perspective view showing a cross-section of the electrophoresis apparatus of FIG. 5.

### DETAILED DESCRIPTION OF THE PREFERRED EMBODIMENTS

According to its first aspect, the invention relates to an apparatus for effecting migration of biomolecules in a gel medium by horizontal electrophoresis, wherein the gel medium is not immersed in the buffer solution.

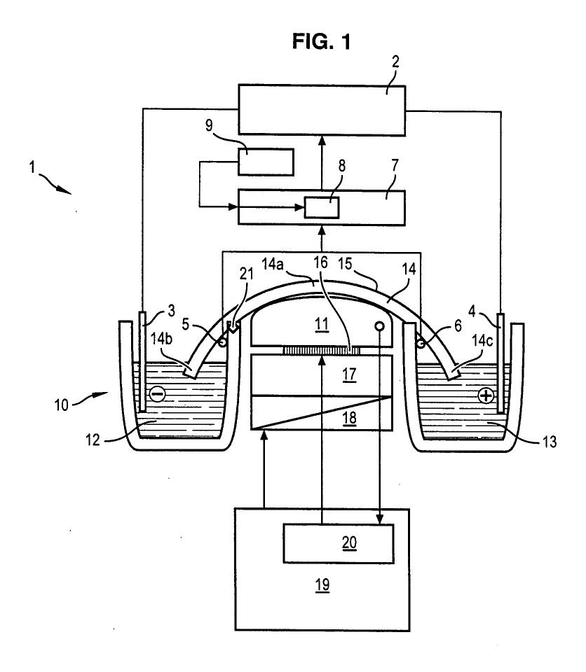

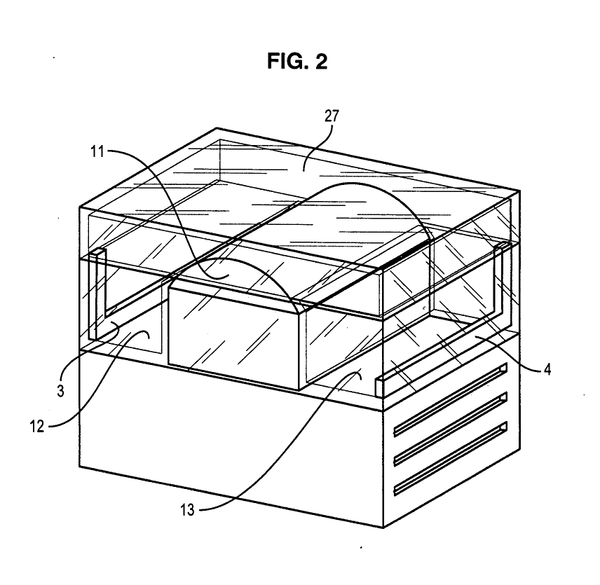

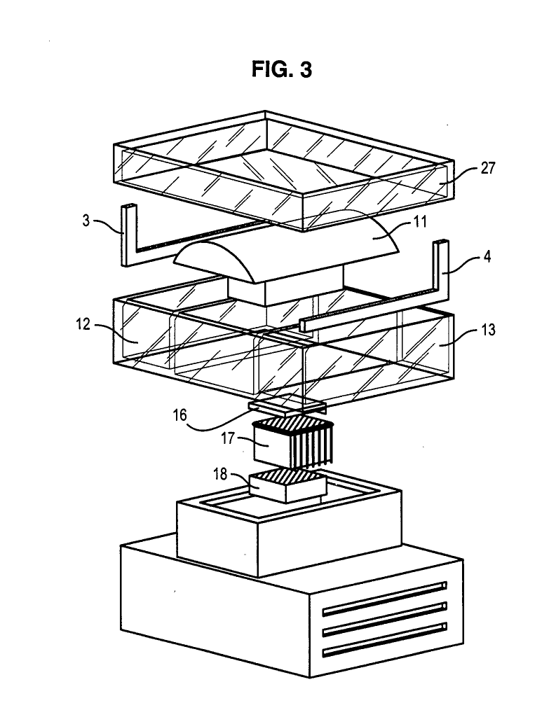

A first embodiment of an electrophoresis apparatus according the first aspect of the invention is shown on FIGS. 1-3.

It has to be noted that this first embodiment proves to be especially suitable for relatively small gels (typically up to 12*12 cm gels) such as those used for electrophoresis of PCR (Polymerase Chain Reaction) products.

The apparatus 1 comprises a tray 10 formed with a support surface 11 for the gel medium 14, 15 linking two buffer solution baths 12, 13. The support surface 11 has longitudinal and lateral dimensions and the buffer solution baths 11, 12 are disposed laterally at each of the longitudinal ends of the support surface.

The support surface is therefore not immersed in the buffer solution, and the tray 10 is conformed so that when the gel medium is disposed on the support surface 11, only the lateral end portions 14b, 14c of the gel medium can dip in the buffer solution contained in the buffer solution baths 12, 13.

The gel medium preferably comprises a film 15, for instance a flexible plastic film, and a gel layer 14 on the film 15.

In the context of this first embodiment, the gel medium is preferably positioned so that the gel layer 14 contacts the support surface 11, with only the lateral end portions 14b, 14c of the gel layer being in contact with the buffer solution contained in the buffer solution baths.

The support surface 11 can notably be rounded to adopt a convex cross-section having the form of an arch with its lateral end portions being the lower parts.

The apparatus further comprises means for applying an electrical potential to the gel medium, consisting of a pair of electrodes 3, 4 having opposite polarities, each electrode being fixed in a respective buffer solution bath 13, 14 and of a power generator 2 for applying an electrical potential between the electrodes 13, 14.

The apparatus further comprises a cover 27, and means configured to prevent that any electrical potential is applied to the electrodes 13, 14 when the cover 27 is not carried over the tray 10.

The gel medium can be positioned with one of the end part of the central portion 14a (typically the one having the wells 21) being retained in contact with the support surface 11 with the lateral portion 14b dipping in the buffer solution bath 12. The other end part of the central portion remains erected in contact with only one side of the support surface 11.

The bottom of the cover 27 may present a positioning element (not shown) which allows when the cover is reported over the tray for retaining the other end part of the central portion 14a in contact with the support surface 11 and for dipping the other lateral portion 14c in the buffer solution bath 13.

Alternatively, a manual positioning can be performed thanks to a positioning element (not shown) in the buffer solution bath 13.

In accordance with the present invention, the apparatus 1 further comprises means for sensing the effective electrical field strength in the gel medium during the electrophoresis process. Such means can for instance comprises a pair of electrodes 5, 6 disposed so as to each contact during the electrophoresis process the non-immersed central portion 14a of the gel medium on one of its end parts, around the limit between the central portion and one of the lateral end portion of the gel medium, the electrodes therefore contributing in measuring the voltage and intensity effectively applied to the gel. The electrodes 5, 6 are connected to an electronic control board 7 which can derive the effective electrical field strength from the electrodes signals.

The apparatus further comprises means 8 for altering the electrical potential applied by the power generator 2 to the electrodes 3, 4 in the buffer solution baths 12, 13 in response to the sensed effective electrical field strength in the gel medium.

In particular, the power generator 2 can apply a variable voltage, typically ranging from 0 to 800 V.

The means 8 for altering can notably be incorporated within the electronic control board 7 and configured so as to alter the electrical potential which is to be applied by the power generator 2 to achieve a preferred effective electrical field strength in the gel medium during the electrophoresis process. Automatic regulation of said strength during the electrophoresis process is therefore obtained.

The preferred effective electrical field strength in the gel medium can in particular be chosen so that migration of biomolecules occurs during a preferred electrophoresis process duration.

On FIG. 1, reference 9 shows the setting of such a preferred effective electrical field strength or preferred duration, to be compared to the sensed effective electrical field strength so as to alter the electrical potential applied by the power generator 2.

Different types of regulation can therefore be implemented by the electronic control board on the basis of the measured effective electrical field in the gel medium. For instance, the regulation can be implemented so as to apply a constant voltage through the gel during the electrophoresis process, or so as to define a constant migration speed or mobility of the biomolecules (which depends upon the electrical potential difference between the end portions of the gel; this value, expressed in Volt/cm, correspond to the ratio between said electrical potential difference and the length of the gel), or more generally accordingly to a control program stored in the electronic control board 7.

It will be understood that such a regulation allows automatic adaptation of the electrophoresis system to the change of the conditions (buffer solution type, gel size, etc.) and precise programming of the electrophoresis conditions, which finally results in improvements in reproducibility and quality of the analyses.

According to a preferred embodiment, the apparatus further comprises cooling means for controlling the temperature of the gel medium.

In the context of the apparatus according to the first embodiment, the cooling means can be configured for cooling the support surface 11 onto which the gel medium is to be disposed, for typically maintaining its temperature around 14° C.

The support surface is for instance the top surface of a block preferably made of a material having a good thermal conductivity, a good mechanical resistance to temperature variations, a good electrical insulation, being chemically inert in particular to corrosion, non porous.

The cooling means can for instance comprises a Peltier element 16 which contacts the base of the block, a heat dissipater 17 and a ventilator 18 below the Peltier element 16, a power generator 19 for the Peltier element and the ventilator and a heat regulator 20.

According to another preferred embodiment, the support surface 11 can comprise a strip of hydrophobic material 22, more preferably a super-hydrophobic material for instance made from Teflon, which can extend in the lateral direction of the support surface so as to seal the wells 21 which are formed in the gel layer 14 to accommodate samples to be migrated.

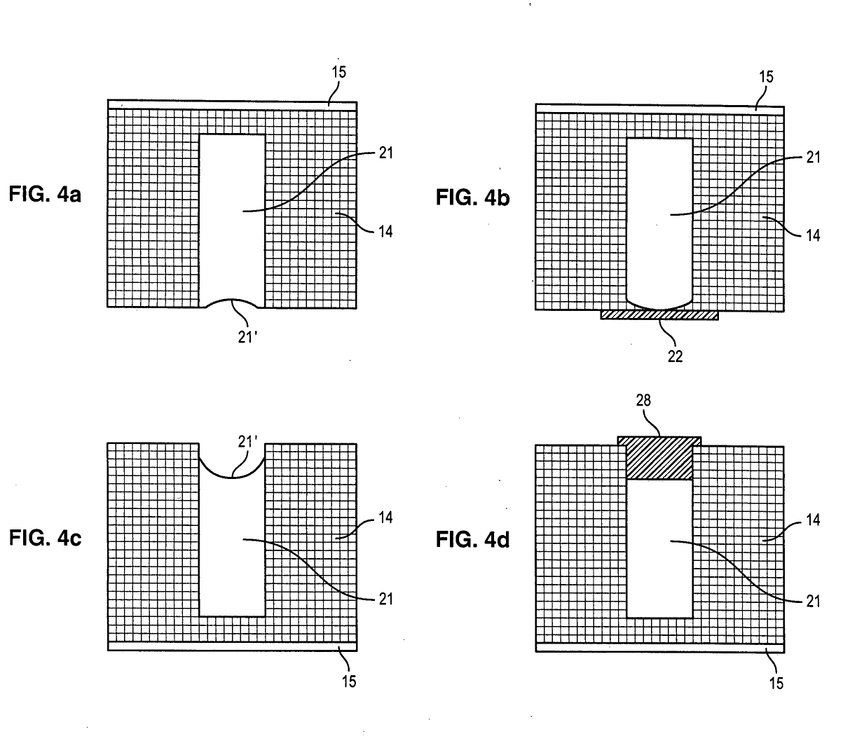

As shown on FIG. 4a, in the absence of such a strip, further to the pouring of the sample to be migrated within a well 21 with, a convex meniscus 21′ can form which may degrade the results of the electrophoresis process.

When a strip 22 of hydrophobic material is provided on the support surface 11 as shown on FIG. 4b, biomolecules to be migrated can be maintained within the well 21 with no meniscus as the well 21 is indeed sealed by the strip 22.

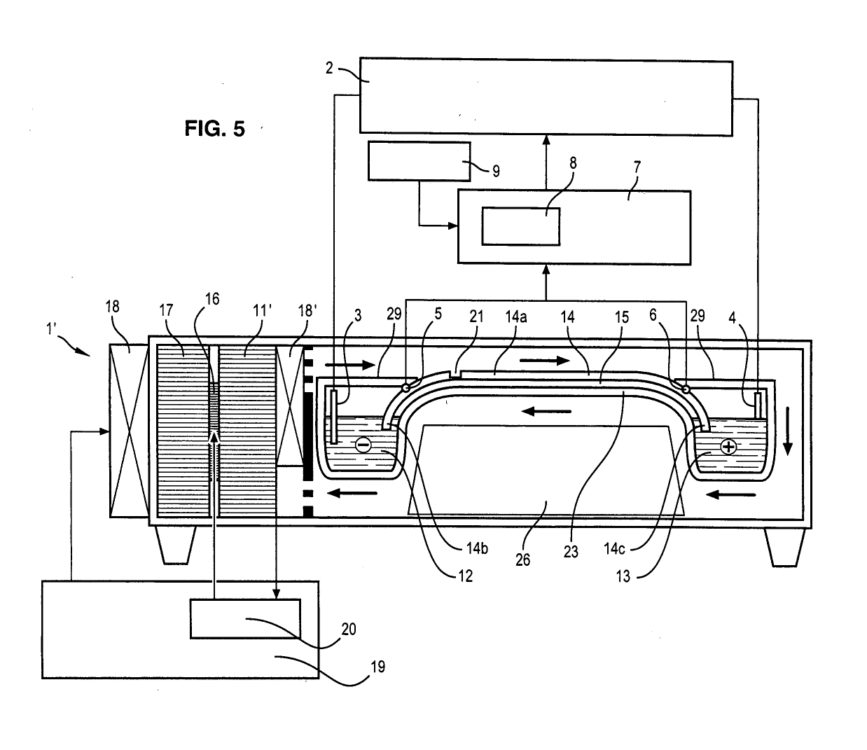

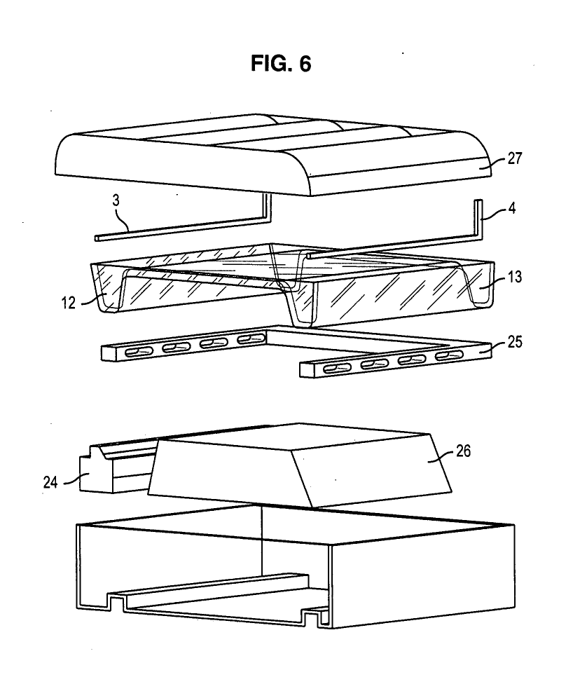

The hereafter description relates to a second embodiment of an electrophoresis apparatus according the first aspect of the invention which shown on FIGS. 5-7.

It has to be noted that this second embodiment proves to be especially suitable for relatively large gels (typically up to 20*20 cm gels) such as those used for screening experiments.

As for the first embodiment, the apparatus 1′ according to this second embodiment comprises a tray formed with a support surface 23 for the gel medium 14, 15 linking two buffer solution baths 12, 13. The support surface 23 has longitudinal and lateral dimensions and the buffer solution baths 12, 13 are disposed laterally at each of the longitudinal ends of the support surface.

The support surface is horizontal and not immersed in the buffer solution. The tray is conformed so that when the gel medium is disposed on the support surface 23, only the lateral end portions 14a, 14b of the gel medium can be immersed in the buffer solution contained in the buffer solution baths 12, 13.

The support surface 23 can be made of UV-transparent plastic, and the apparatus can further comprise a transilluminator 26 capable of directing UV light to the gel trough the support surface once the electrophoresis process is completed, to assist in the reading of the migration results.

As for the first embodiment, the apparatus further comprises means for applying an electrical potential to the gel medium (including the pair of electrodes 3, 4 having opposite polarities, each being fixed in a respective buffer solution bath 12, 13), means for sensing the effective electrical field strength in the gel medium during the electrophoresis process (for instance comprising a pair of electrodes 5, 6 disposed on the support surface 23 so as to each contact during the electrophoresis process the non-immersed central portion 14a of the gel medium on one of its end parts, around the limit between the central portion and one of the lateral end portion 14b, 14c of the gel medium) and means for altering the electrical potential applied by the power generator to the electrodes 3, 4 in the buffer solution baths 12, 13 in response to the sensed effective electrical field strength in the gel medium.

According to a preferred embodiment, the apparatus further comprises cooling means for controlling the temperature of the gel medium. In the context of the apparatus according to the second embodiment, the cooling means can be configured to generate a flow of cold air above the support surface (as illustrated by the arrows on FIG. 5).

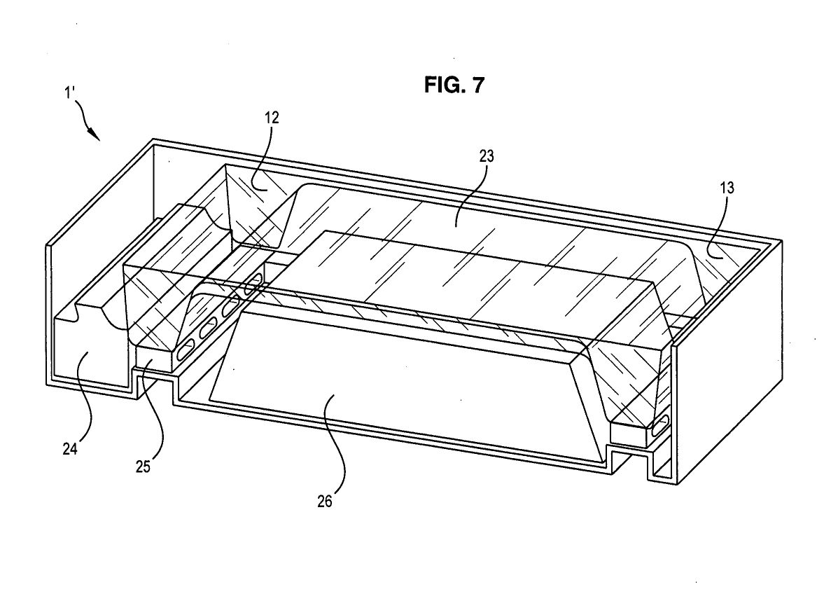

The cooling means can for instance comprises a Peltier element 24 and an air diffuser 25, for instance in aluminium, positioned below the tray as shown on FIG. 7.

The gel medium preferably comprises a film 15, for instance a flexible plastic film, and a gel layer 15 on the film. In the context of this second embodiment, the gel medium is preferably positioned so that the film 15 contacts the support surface 23, with only the lateral end portions of the gel layer being in contact with the buffer solution contained in the buffer solution baths.

The gel layer can further be protected against dehydration by a very thin plastic film. It has to be noted that such film also prevent moisture diffusion within the cooled apparatus.

Plates 29 which cover the buffer solution baths can be used so as to maintain the gel medium on the support surface with its lateral end portions dipping within the buffer solution baths. These plates could further comprise the electrodes 5, 6 used to sense the effective electrical field strength in the gel medium.

The invention is not limited to the apparatus according to its first aspect, but also relates to a method for effecting migration of biomolecules in a gel medium by horizontal electrophoresis, comprising the steps of:

applying an electrical potential to the gel medium

sensing the effective electrical field strength in the gel medium

altering said electrical potential in response to the sensed effective electrical field strength in the gel medium.

In particular, such method can be implemented with the apparatus according to the first embodiment above with the gel layer contacting the rounded support surface, or with the apparatus according to the second embodiment above with the film contacting the horizontal support surface.

The wells 21 in the gel layer 14 can further be sealed before the electrophoresis process by a super-hydrophobic material such as Teflon (as for instance referred in the article “Super-hydrophobic surfaces made from Teflon” by Pieter Van der Wal and Ullrich Steiner, in Soft Matter, 2007, 3, 426-429), or as shown on FIGS. 4c-4d by a material 28 which is hydrophobic and liquid at ambient temperature but which jellifies at the temperature of the gel during the electrophoresis process (typically 14° C.). Such material 28 will indeed enter the well, thus preventing evaporation of the sample poured into the well while maintaining the surface horizontal with no meniscus. Examples of such material are paraffins, such as hexadecane (molecular formula: C₁₆H₃₄; melting point=18° C.), eicosane (molecular formula C₂₀H₄₂; melting point=37° C.) and octadecane (molecular formula C₁₈H_{38;} melting point=28-30° C.). Hexadecane is advantageous in that it is liquid at ambient temperature (25° C.) and jellifies once in contact with the gel. On the other hand, a preliminary heating of eicosane and octadecane is needed so as to surpass their melting point before sealing the wells.

It will be noted that the proposed sealing of the wells is in no way limited to an implementation in the context of the use of an apparatus according to the first aspect of the present invention, but can more generally be implemented as a preliminary step to a gel electrophoresis process whatever the electrophoresis apparatus.

1. Apparatus (1, 1′) for effecting migration of biomolecules in a gel medium (14, 15) by electrophoresis, comprising:
means (2, 3, 4) for applying an electrical potential to the gel medium (14, 15);
means (5, 6, 7) for sensing the effective electrical field strength in the gel medium (14);
means (8) for altering the applied electrical potential in response to the sensed effective electrical field strength in the gel medium.

2. Apparatus according to claim 1, wherein the means for altering (8) is configured so as to alter said electrical potential to achieve a preferred effective electrical field strength in the gel medium.

3. Apparatus according to claim 2, wherein said preferred effective electrical field strength is chosen so that migration of the biomolecules occurs during a preferred duration.

4. Apparatus according to any of the preceding claims, comprising a tray (10) formed with a support surface (11, 23) for the gel medium linking two buffer solution baths (12, 13).

5. Apparatus according to claim 4, wherein the tray is conformed so that when the gel medium is disposed on the support surface, only the end portions (14a, 14b) of the gel medium are immersed in the buffer solution baths (12, 13).

6. Apparatus according to any one of claim 4 or 5, wherein said means for applying an electrical potential to the gel medium comprises a pair of electrodes (3, 4), each electrode being fixed in respective a buffer solution bath (13, 14), and a power generator (2) for applying an electrical potential between the electrodes (13, 14).

7. Apparatus according to any one of claims 5 to 6, wherein the means for sensing the effective electrical field strength in the gel medium comprises a pair of sensing electrodes (5, 6) disposed so as to each contact the non-immersed central portion (14c) of the gel medium on one of its end parts.

8. Apparatus according to any one of the preceding claims, further comprising cooling means (15-19; 24-25) for controlling the temperature of the gel medium.

9. Apparatus according to claim 8, wherein the cooling means (24-25) generates a flow of cold air around the support surface (23) and the gel medium.

10. Apparatus according to claim 8, wherein the cooling means (15-19) cools the support surface (11).

11. Apparatus according to any one of claims 1-10, wherein the support surface (23) is horizontal.

12. Apparatus according to any one of claim 1-10, wherein the support surface (11) is rounded.

13. Apparatus according to claim 12, wherein the support surface comprises a strip (22) of hydrophobic material onto which wells (21) in the gel medium for pouring samples to be migrated are to be positioned.

14. Method for effecting migration of biomolecules in a gel medium by horizontal electrophoresis, comprising the steps of
applying an electrical potential to the gel medium
sensing the effective electrical field strength in the gel medium
altering said electrical potential in response to the sensed effective electrical field strength in the gel medium.

15. Method according to claim 14 wherein the gel medium comprises a film (15) and a gel layer (14) on the film, further comprising the step of positioning the gel medium in the apparatus according to claim 11 with the film contacting the horizontal support surface.

16. Method according to claim 14 wherein the gel medium comprises a film (15) and a gel layer (14) on the film, further comprising the preliminary step of positioning the gel medium in the apparatus according to any one of claim 12 or 13 with the gel layer contacting the rounded support surface.

17. Method according to claim 15 or 16, further comprising the preliminary step of sealing the well (21) in the gel medium into which biomolecules to be migrated has been poured.
